(19) United States
(12) Patent Application Publication
(10) Pub. No.: US 2005/0074990 A1
(43) Pub. Date: Apr. 7, 2005

(54) Optics pack

(76) Inventors: Simon E. Shearman, Ontario (CA); Keith Kilgour, Ontario (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/680,328

(22) Filed: Oct. 6, 2003

(51) Int. Cl. H01R 12/00

(52) U.S. Cl. 439/65

(57) ABSTRACT

An optics pack including a housing unit having multiple slots configured to accept optical modules, a stack interconnect having a connector associated with a slot of the multiple slots of the housing unit, and an optics pack connector electrically coupled to the connector of the stack interconnect.

### BACKGROUND

This invention relates to an optics pack.

Optical modules used in fiber optics networks operate at varying optical carrier transmission speeds. Each optical module plugs into an I/O slot in a back plane of a switch shelf. The switch shelf can be, for example, High Density Cross connect (HDX) or mini HDX (MDX) dependent on the number of slots. Each I/O slot on a switch shelf can be of any transmission speed, because the digital processing on the pluggable carrier of each I/O slot will groom the signal to the same speed for transmission across the back plane to cross connect to other slots. Every switch location requires a different service mix. The operator may desire more service rates than number of slots on the switch shelf. Small form pluggable (SFP) and 10 Gigabit small form pluggable (XFP) devices allow the signaling rate to be converted, but the operator must choose a device to match the optical module and the slot. Therefore, multiple types of XFP and SFP devices may be needed in an optical shelf because the devices are not interchangeable. The size of these XFP and SFP devices may limit an optics mix achievable in a small shelf on the receiving device.

### SUMMARY

In one aspect the invention features an optics pack including a housing unit having multiple slots configured to accept optical modules, a stack interconnect having a connector associated with a slot of the multiple slots of the housing unit, and an optics pack connector electrically coupled to the connector of the stack interconnect.

Embodiments may include one or more of the following. The pack includes a main circuit board to supply an electrical path to couple the optics pack connector to the connector of the stack interconnect. The pack has a circuit board to supply an electrical path to couple the optics pack connector to the connector of the stack interconnect. The board is configured to convert a first signaling rate associated with an optical module that is inserted into the slot to a second signaling rate associated with a device coupled to the optics pack connector. The optical modules share a common set of circuitry in the circuit module. In another example, the pack includes status indicators associated with operation of the module or a slot. The faceplate may include the status indicators. The stack interconnect is connected to the circuit board. The stack interconnect includes a repeater to relay a signal or a connection to the circuit module. The pack includes two faceplates separated from each other by a slot in the housing, a light pipe, and/ or a heat sink. The heat sink may be included in an upper part of the housing.

In another embodiment, the stack interconnect can include a riser board and a mezzanine connector. The stack interconnect can include a riser board and a mezzanine connector to electrically couple the connector and the main circuit board. The mezzanine connector can include a male portion and a female portion. The male portion of the mezzanine connector attaches to the circuit board and the female portion of the mezzanine connector attaches to the riser board. In another example, a female portion of the mezzanine connector attaches to the main circuit board and a male portion of the mezzanine connector attaches to the riser board. The riser board can be removably coupled to a main board.

The pack may also include a second riser board and a second mezzanine connector. In this example, the first mezzanine connector attaches a first riser board to a top side of the circuit board and the second mezzanine connector attaches a second riser board to a bottom side of the main circuit board. The mezzanine connectors can include a plastic body and metal contacts.

One or more aspects of the invention may provide one or more of the following advantages.

The optical module includes a stack interconnect arrangement that splits a single row of slots in the receiving device into an array of slots in the carrier pack. Each slot is configured to accept an optical module, thus, increasing choices available for mixing different types of modules while still fitting into the space allowed for a single slot.

The carrier pack includes a stack interconnect arrangement with mezzanine connectors and riser boards. The arrangement permits removal of a single riser board in the event of a board failure without necessitating the replacement of a main circuit board. Whereas, if circuitry on the main circuit board fails, the main circuit board can be replaced with a new circuit board and the riser boards can be removed from the failed main circuit board and attached to the new main circuit board. T

The stack interconnect arrangement can accommodate multiple types of optical modules. Since many different optical modules can fit into a single slot on the carrier pack, the carrier pack provides the advantage of allowing a single pack to be used for multiple optical modules so user does not have to match the correct type of pack to a module. The arrangement also permits optical modules to be “hot pluggable.” This allows an operator to add, remove, or swap optical devices while the system is in use without disrupting the operation of the other modules

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an optics pack.

FIG. 2 is a side view of the optics pack of FIG. 1.

FIG. 3 is a top view of the optics pack of FIG. 1.

FIG. 4 is a perspective view of a bottom tray portion of the optics pack holding a circuit board.

FIG. 5 shows an interconnect arrangement.

FIG. 6 shows an alternate interconnect arrangement.

FIG. 7 is an alternate embodiment of the optics pack.

FIG. 8 shows the circuit board inside the optics pack.

### DETAILED DESCRIPTION

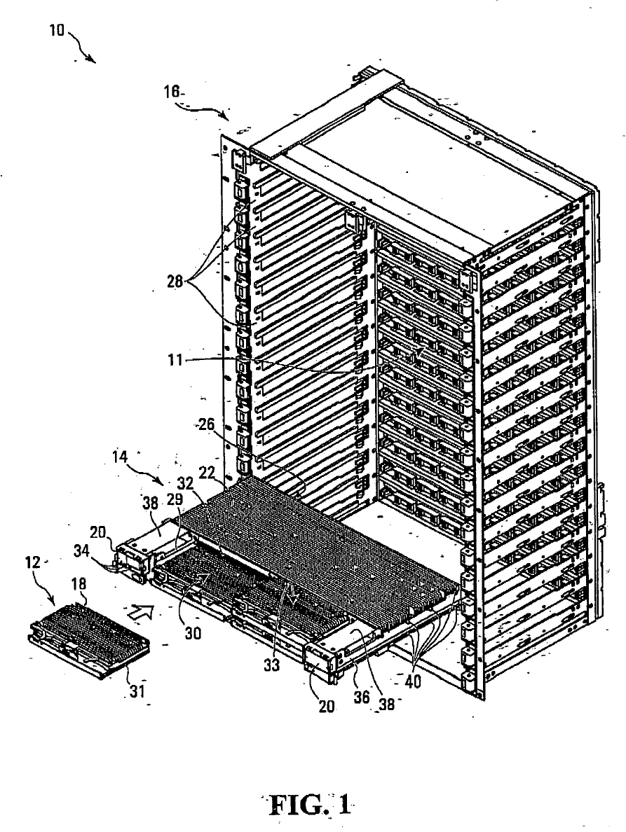

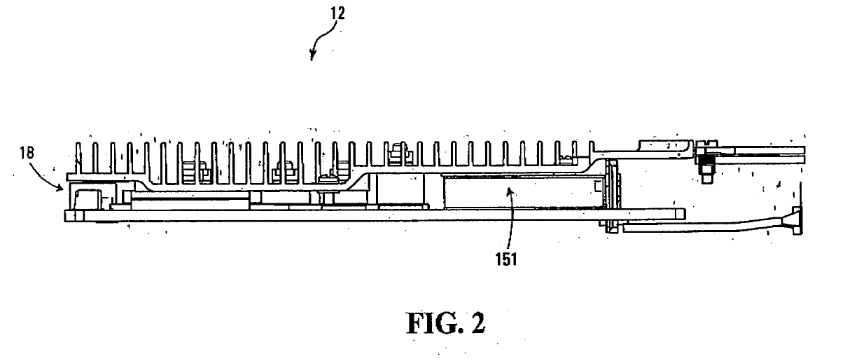

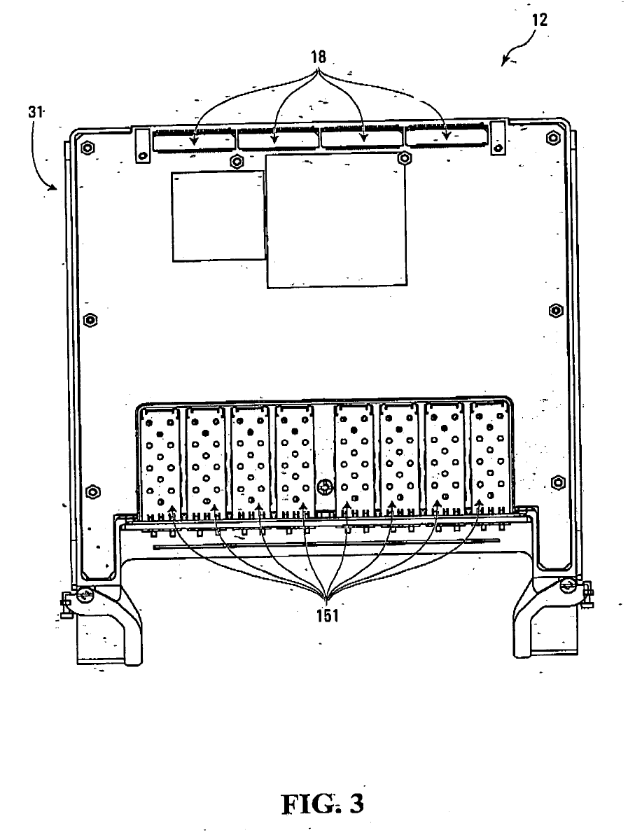

Referring to FIGS. 1-3, a system 10 includes a carrier pack 14 having slots 30 to accept optical modules 12. The carrier pack 14 connects to an optical back plane 16 of a switch shelf Multiple ones of the optical modules 12 may be connected to the carrier pack 14. Signals from the multiple optical modules 12 are transmitted through the carrier pack 14, as discussed below, and outputted from the carrier pack 14 on an output connector 26 (FIGS. 2 and 3) of the carrier pack 14. The output signals from the carrier pack 14 are received on a single I/O slot 28 on the optical back plane 16. Similarly, signals from the I/O slot 28 are received by carrier pack 14 and transmitted to optical module 12. Carrier pack 14 includes a housing 17 including a faceplate 20 having slots 30 recessed from faceplate 20 to allow the optical modules 12 to be plugged into carrier pack 14. The slots 30 have connectors 32 to mate with a connector 18 on optical module 12 and provide a connection between carrier pack 14 and optical module 12. Multiple slots 30 are included to form columns 33 of optical modules 12. The slots 30 and mating features 32 are configured to allow a variety of optical modules 12 to be plugged into the carrier pack 14. The slots may also include guide rails 29 to assist a user in plugging a module 12 into the carrier pack 14. A feature 31 such as a strip on the side of the module fits into the guide rails 29 aligning the connector on the module 18 with the connector 32 in slot 30.

The housing of carrier pack 14 includes a heat sink region 22, endcaps 36, faceplate 20, and topside panels 38. A set of screws 40 connect the faceplate 20, topside panel 38, heat sinking region 22, and endcaps 36. Alternately, adhesive bonding or other fastening techniques can be used to connect the components forming the carrier pack. The housing may be composed of plastic, metal, or a combination of materials.

The carrier pack houses a circuit board (not shown). During operation the circuit board generates heat, thus, a heat sink 22 is provided on the carrier pack 14. In this example, heat sink 22 includes fins. Airflow across the fins cools the fins and dissipates heat from the heat sink region.

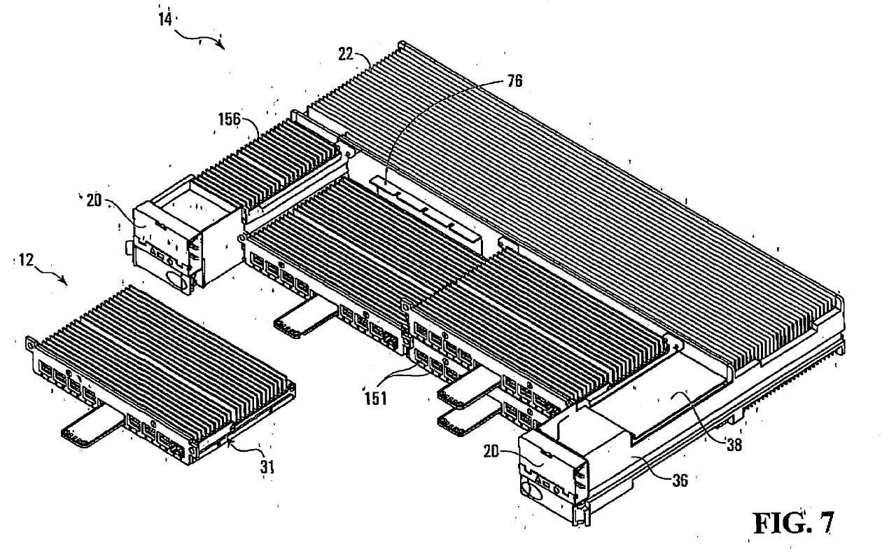

Faceplate 20 includes a light emitting diode (LED) 34 functioning as a status indicator. Color-coding of LED 34 allows an operator to de-bug the functionality of the module. For example, a coding system may be used which associates a red LED with a failure, a yellow LED with an error in which the device is still at least partially functional, and a green LED with normal operation. This color-coding system enables an operator to diagnose the functionality of the system 10. The carrier pack may include multiple sets of status indicating LEDs. For example, a carrier pack may include three sets of LEDs: a first set of LEDs reflecting the functionality of the I/O slot 28 in the optical back plane 16, a second set of LEDs reflecting the status of the carrier pack 14, and a third set of LEDs indicating the status of a pluggable optic device 151 (FIG. 7) such as an SFP, or and XFP if there are more than one pluggable device on the optical module. Thus, when an operator desires to debug the system, the operator can determine if a failure is associated with I/O slot 28, carrier pack 14, or pluggable optic device 151. In another example, the status indicators may include an LCD panel. The LCD panel displays information on the status of the module, pack, and/or slot.

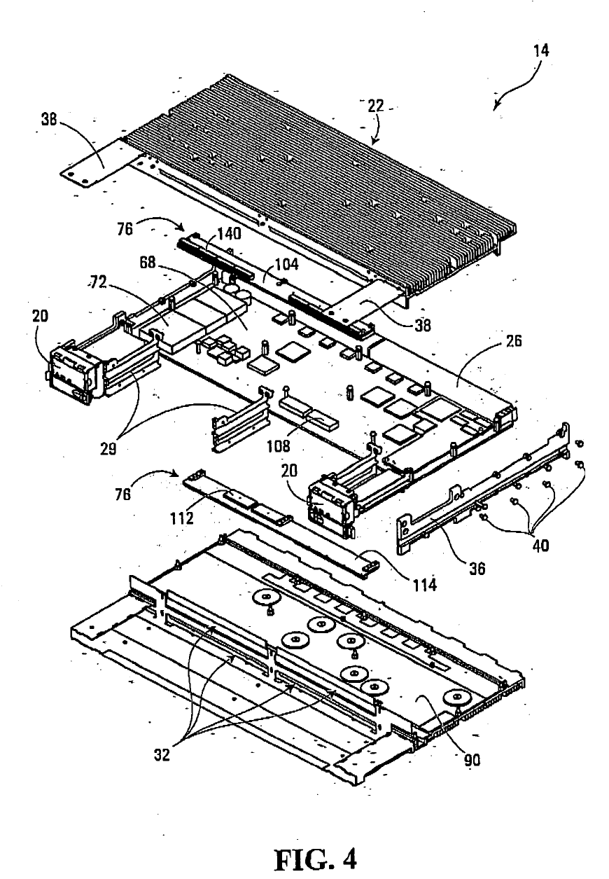

Referring to FIG. 4, carrier pack 14 includes a circuit board 68 disposed in the carrier pack 10 under the heat sink 22. The heat sink 22 lies above the circuit board for heat dissipation. The circuit board 68 attaches to heat sink 22. End caps 36 attach to circuit board 68 and heat sink 22. The end caps may include a feature such as a strip to align the carrier pack 14 to I/O slot 28 in back plane 16. The connector slots 32 of the housing match with a connector device 76 on circuit board 68. The connector device 76 provides a path for a signal to travel from the optical module 12 to the circuit board 68.

Circuit board 68 includes routing, power, and circuitry to accept signals from the optical modules 12 and to route signals to optical module 12. The optical modules may operate at different signaling rates from each other or at a different signaling rate from the I/O slot 28 into which the carrier pack 14 is plugged. Thus, the circuit module on circuit board 68 converts the signals received from optical modules 12 over the connectors 24 to a common signaling rate. This configuration allows multiple optical modules 12 to share a common set of circuitry that may include some or all of the following: a power regulator 72, an electro-optics micro controller 88, a TCS daughter card 82 configured to synchronize and control timing and provide a clock generator for the system, and a back plane repeater 74 to boost signal strength as the signal degrades due to the length the signal travels on the board. The circuit board also includes ASICS configured to allow the optical modules 12 to be “hot pluggable.” This allows an operator to add, remove, or swap optical devices while the system is in use without disrupting the operation of the other modules 12 on carrier pack 14.

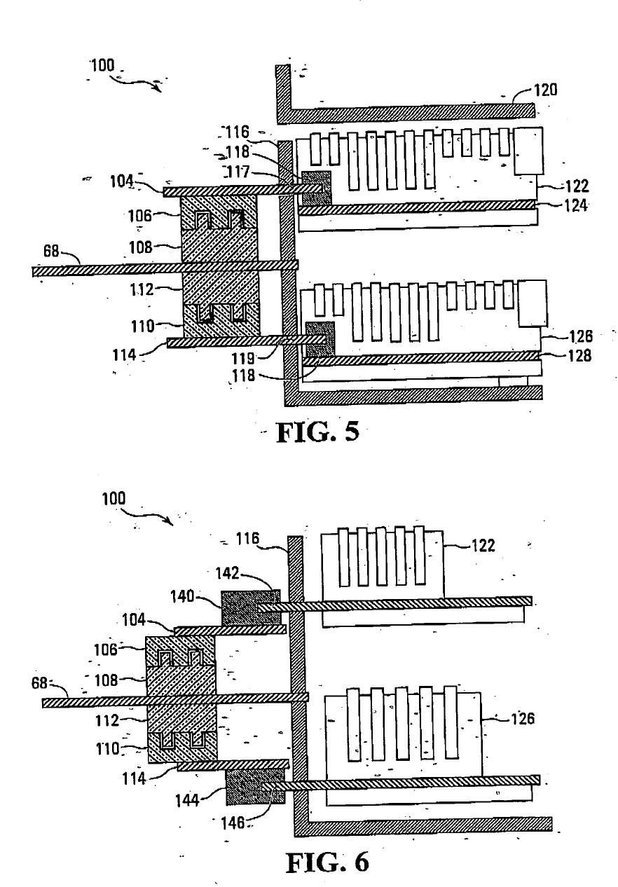

Referring to FIG. 5, a stack interconnect arrangement 100 in carrier pack 14 allows a column of optical modules 12 to be connected to circuit board 68. A first optical module 122 plugs into an upper connector 117 and a second optical module 126 plugs into a lower connector 119. The spacing between the connectors 117 and 119 allows the two optical modules to fit into a limited space such that a second carrier pack may be plugged into a slot above the current carrier pack. In this case, the bottom 120 of the second carrier pack would lie directly above the top optical module as shown. The stack interconnect arrangement 100 provides spacing between the modules.

In the top slot in stack interconnect arrangement 100, a connector 118 on module 122 mates with connector 117 on a riser circuit board 104. The module 122 includes a printed circuit board 124. When connected, a communication path exists between the printed circuit board 124 and the riser circuit board 104.

A set of connectors, e.g., so-called mezzanine connectors 106 and 108 connect the main circuit board 68 to a riser printed circuit board 104. A mezzanine connector is a connector including an array of pins in rows and columns used to pass multiple signals through a small area. Mezzanine connectors have a male and female portion which mate and un-mate with application of force pushing the pins of the male connector into the receptacles of the female connectors. The mezzanine connectors allow high-speed differential pair signals traversing the connector to maintain the signal integrity. Thus, a communication path exists between optical module 122 and main board 68. In one arrangement, to provide the communication path using the mezzanine connectors, a first male mezzanine connector 108 attaches to the topside of the circuit board 68 and a female mezzanine connector 106 connects to the riser board 104. The mezzanine connectors separate the riser printed circuit board from the main board 68. When the male mezzanine connector 108 is connected to the female mezzanine connector 106, a communication path forms between the main circuit board and the riser board 104. Thus, when module 122 is plugged into connector 117 a communication path exists between the module 122 and the main board 68. The mezzanine connectors 106 and 108 can be separated allowing removal of riser board 104 from the main circuit board 68. The removal of a single riser board may be advantageous in the event of a board failure. For example, if a riser board fails within the pack the riser board is removed and replaced without necessitating the replacement of the main circuit board. On the other hand, if circuitry on the main circuit board fails, the main circuit board can be replaced with a new circuit board and the riser boards can be removed from the failed main circuit board and attached to the new main circuit board. In order to remove riser board 104 from main circuit board 68, the user disassembles carrier pack 14 (i.e. removes end caps 68 and heat sink 22) and applies a force to separate the male portion 108 of the mezzanine connector from the female portion of the mezzanine connector 106.

Similarly, to provide the bottom connection, a second male connector 110 attaches to the bottom side of the main board 68. Male connector 110 connects to female connector 112 that attaches to riser board 114.

Mezzanine connectors 106, 108, 110, and 112 may include a plastic body with metal contacts. In one example, the mezzanine connector attaches to the printed circuit board using ball grid array (BGA) or compliant pins with post soldering. In a BGA mount, the package includes bond wires connected to a laminate and the laminate connects to the bond wires (e.g. small solder balls) underneath the package. The customer solders the bond wires directly to the board, thus reducing a floor space on the board. However, alternate connection methods are feasible.

In another example, the mezzanine connector attaches to the printed circuit board using a flexible pcb connection in which a board edge host connector is on the main board. A flexible pcb plugs into the connector that is rigid at either end with gold finger contacts. The finger contacts mate to the host connector on main card end and directly into the optical module on the other end. The opposite end is tied to the carrier housing to prevent movement while the optical module is inserted.

The attachment of the male and female connectors could be reversed such that the female connector attaches to the main board and the male connector attaches to the riser printed circuit board. A second optical receiver pack 12 could be plugged in to a second I/O slot directly above the first I/O slot 28 in the back plane. In this case, the bottom 120 of the second receiver pack would lie directly above the top optical module as shown.

Referring to FIG. 6, the stack device 100 may alternately include the connectors 117 and 119 attached to a set of second riser circuit boards 142 and 146 respectively. Connection devices 140 and 144 connect the second riser circuit boards 142 and 146 to the top and bottom riser circuit boards 104 and 114. The connections between the modules 122 and 126, riser boards, and main board 68 are similar to those discussed concerning FIG. 5.

In another example, the male and female set of mezzanine connectors is replaced with a single non-separable connector. A first end of the non-separable connector connects to the main circuit board while a second end of the connector connects to the riser board forming a communication path between the riser board to the main circuit board.

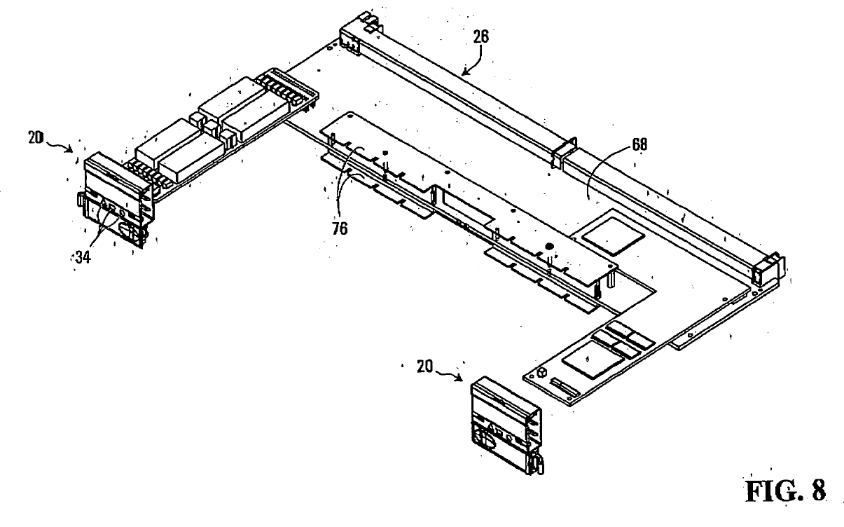

Referring to FIG. 7 and FIG. 8, the optical pack is configured to handle 80 Gigabit per second of traffic or greater. In this example, as before the carrier pack 12 is multi-service pluggable and may accept small form pluggable (SFP) and 10 Gigabit small form pluggable (XFP) devices operating at various signaling rates. In this example, reducing extent of heat sink region 22 reduces the overall length of carrier pack 14. To account for the reduced heat dissipation, a second set of heat sinking devices 156 may replace one or both of the topside panels. The circuit board 68 (FIG. 8) includes a reduced number of ASICS that perform the needed functionality or some of the functionality may be transferred to the optical devices.

In the preceding examples, the optical modules 12 may include but are not limited to one or more of the following carrier speeds: 8×OC3/ 12 SFP, 8×OC 48 SFP, 8×GbE SFP, 2×10G XFP, and 2×10GE XFP. Optical Carrier transmission speeds, used in fiber optic networks conform to SONET standard where OC-1 is 51.85 Mbps. Higher levels are multiples of that speed.

A number of embodiments of the invention have been described. Nevertheless, it will be understood that various modifications may be made without departing from the spirit and scope of the invention. Accordingly, other embodiments are within the scope of the following claims.

1. A carrier pack comprising
a housing unit having multiple slots configured to accept optical modules;
a stack interconnect having a connector associated with a slot of the multiple slots of the housing unit;
a carrier pack connector electrically coupled to the connector of the stack interconnect.

2. The carrier pack of claim 1, further comprising:
a main circuit board to supply an electrical path to couple the carrier pack connector to the connector of the stack interconnect.

3. The carrier pack of claim 1, further comprising:
a main circuit board to supply an electrical path to couple the carrier pack connector to the connector of the stack interconnect and configured to convert a first signaling rate associated with an optical module that is inserted into the slot to a second signaling rate associated with a device coupled to the carrier pack connector.

4. The carrier pack of claim 3 wherein multiple optical modules, each optical module associated with one of the multiple slots of the carrier pack, share a common set of circuitry on the main circuit board.

5. The carrier pack of claim 1 wherein the stack interconnect is connected to a main circuit board.

6. The carrier pack of claim 1 wherein the stack interconnect includes a riser board and a mezzanine connector.

7. The carrier pack of claim 2 wherein the stack interconnect includes a riser board and a mezzanine connector to electrically couple the connector and the main circuit board.

8. The carrier pack of claim 6 wherein the mezzanine connector includes a male portion and a female portion.

9. The carrier pack of claim 7 wherein the mezzanine connector includes a male portion and a female portion, the male portion of the mezzanine connector attaching to the main circuit board and the female portion of the mezzanine connector attaching to the riser board.

10. The carrier pack of claim 8 wherein the riser board is removably coupled to a main circuit board.

11. The carrier pack of claim 7 wherein a female portion of the mezzanine connector attaches to the main circuit board and a male portion of the mezzanine connector attaches to the riser board such that the riser board is removably coupled to the main circuit board.

12. The carrier pack of claim 7, further comprising a second riser board and a second mezzanine connector wherein the mezzanine connector attaches the riser board to a top side of the main circuit board and the second mezzanine connector attaches the second riser board to a bottom side of the main circuit board.

13. The carrier pack of claim 7 wherein the mezzanine connectors include a plastic body and metal contacts.

14. (Cancelled)

15. The carrier pack of claim 2 wherein the stack interconnect includes a connection to a common set of circuitry on the main circuit board.

16. The carrier pack of claim 1, further comprising
two faceplates separated from each other by a slot in the housing.

17. The carrier pack of claim 1, further comprising
a heat sink.

18. The carrier pack of claim 17 wherein an upper part of the housing includes the heat sink.

19. (Cancelled)

20. The carrier pack of claim 1, further comprising
status indicators associated with operation of the module or a slot of the multiple slots of the housing unit.

21. The carrier pack of claim 20, wherein a faceplate includes the status indicators.

22. An optics pack comprising:
a carrier pack comprising
a housing unit having multiple slots adapted to receive optical modules;
a stack interconnect having a connector associated with a slot of the multiple slots of the housing unit;
a carrier pack connector electrically coupled to the connector of the stack interconnect; and
a plurality of optical modules each comprising a connector adapted to electrically couple the optical module with the connector of the stack interconnect of the carrier pack.

23. An optics pack according to claim 22 configured to convert a first signaling rate associated with an optical module that is inserted into a slot of the multiple slots of the housing unit to a second signaling rate associated with a device coupled to the carrier pack connector.

24. A system comprising:
at least one carrier pack comprising
a housing unit having multiple slots adapted to accept optical modules;
a stack interconnect having a connector associated with a slot of the multiple slots of the housing unit;
a carrier pack connector electrically coupled to the connector of the stack interconnect;
a plurality of optical modules, each optical module comprising a connector adapted to electrically couple the optical module with the connector of the stack interconnect of the at least one carrier pack; and
a switch self adapted for receiving the at least one carrier pack, the switch shelf comprising a back plane adapted to couple the switch shelf with the carrier pack connector of the at least one carrier pack.
